(19) United States
(12) Patent Application Publication
(10) Pub. No.: US 2020/0010941 A1
(43) Pub. Date: Jan. 9, 2020

(54) NON-UNIFORM HEAT TREATMENT FOR CUSTOM SPATIAL STRENGTH AND FORMABILITY

(71) Applicant: Novelis Inc., Atlanta, GA (US)

(72) Inventors: Peter Lloyd Redmond, Acworth, GA (US); Rajeev G. Kamat, Marietta, GA (US); Aude Celine Despois, Grone (CH); Sazol Kumar Das, Acworth, GA (US); Richard Burrows, Acworth, GA (US)

(73) Assignee: Novelis Inc., Atlanta, GA (US)

(21) Appl. No.: 16/503,870

(22) Filed: Jul. 5, 2019

Related U.S. Application Data
(60) Provisional application No. 62/694,507, filed on Jul. 6, 2018.

(51) Int. Cl. C22F 1/04; B32B 15/04; B32B 15/08; B32B 15/14; B32B 15/20; B21D 22/02

(52) U.S. Cl. CPC C22F 1/04; B32B 15/043; B21D 22/02; B32B 15/14; B32B 15/20; B32B 15/08

(57) ABSTRACT

Described are metal products having spatially non-uniform strength and formability profiles. The spatial non-uniformity of these properties may be achieved by heat-treating the metal product in a spatially non-uniform fashion, such that different portions of the metal product exhibit different strength and formability characteristics. The metal products may be formed into stamped products, with strength and formability characteristics customized to allow for suitable drawing during the stamping process.

### CROSS-REFERENCE TO RELATED APPLICATIONS

This application claims the benefit of and priority to U.S. Provisional Application 62/694,507, filed on Jul. 6, 2018, which is hereby incorporated by reference in its entirety.

### FIELD

The present disclosure relates to metallurgy generally and more specifically to metal products exhibiting non-uniform strength and formability characteristics, formed metal products, methods for making and using metal products exhibiting non-uniform strength and formability, and methods for making formed metal products.

### BACKGROUND

The strength and formability of metals can be modified by working the metal and heat treating the metal. For example, aluminum alloy products may be cold worked to increase strength, but this increase in strength may come at the expense of reduced formability character. Certain alloys may be tempered to increase formability, but this increase in formability may come at the expense of reduced strength. Other alloys, however, may have their strength increased by heat treatment.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

In an aspect, described are metal products, such as a metal product having non-uniform strength and formability characteristics. The strength and formability characteristics may be spatially tailored for a specific target application. These spatially tailored properties may be generated through non-uniform application of heat treatment and/or quenching to the metal product. For example, a metal product, such as sheet metal, that is to be stamped into a part may benefit from increased formability characteristics at certain positions of the product, while strength at other positions may be advantageous and/or desirable. Methods of heat treatment are also described herein. Advantageously, an array of heating, cooling and/or quenching sources may be used for heat treatment of a metal product.

Generally, the disclosed metal products exhibit strength and formability characteristics that vary across the spatial area or volume of the metal. For example, some regions of the metal product may exhibit high strength and low formability characteristics, while other regions may exhibit low strength and high formability characteristics. In this way, spatially customized metal products may be obtained to meet certain requirements or desired properties in an end product or an intermediate product.

Certain metal alloys, such as non-heat-treatable alloys, may obtain increased formability characteristics through the application of heat treatments (i.e., tempering). Strength and formability characteristics may also be altered by other processes. For example, 3xxx series, 4xxx series, and 5xxx series aluminum alloys may be strengthened by cold working, while improved formability characteristics and reduction of strength may be achieved through the application of a heat treatment that results in tempering the metal.

Other metal alloys, such as heat-treatable alloys, may be strengthened by appropriate heat treatment (i.e., solution heat treatment and quenching) as well as other processes. For example, 2xxx series, 6xxx series, and 7xxx series aluminum alloys may be strengthened by cold working, solution heat treatment and quenching and, optionally, artificial aging. Formability characteristics of heat-treatable alloys may also be increased through the application of certain heat treatments.

Spatially non-uniform heat treatments may be applied to a metal product using a variety of techniques, such as by using one-dimensional or two-dimensional arrays of heating, cooling, and/or quenching elements. In some examples, magnetic (or electromagnetic) induction heating techniques may be applied to a metal product in a spatially non-uniform fashion, where eddy currents are induced within the metal by exposure to rotating magnetic fields from a series of magnetic sources (or pairs or multiple magnetic sources) to inductively heat portions of the metal according to a desired spatial configuration. The distance between the metal product and the source of a rotating magnetic field, which may be a permanent magnet or an electromagnet, may impact the rate at which heating takes place. Similarly, the rate of rotation of the magnetic field may impact the heating rate. The strength of the magnetic field may also impact the heating rate. A gap spacing between adjacent magnetic sources may also impact the heating rate. In some cases, multiple series of rotating magnetic fields may be applied to a metal product, which may optionally be in motion, to achieve particular heating rates or drive the portions of the metal product to particular temperatures for a particular amount of time to achieve a desired spatially non-uniform temperature distribution within the metal product.

Optionally, flame impingement techniques may be applied to heat treat portions of a metal product in a spatially non-uniform fashion, such as where a series of individually actuatable fuel burners are used to heat portions of the metal product to achieve a particular temperature distribution. As examples, the distance between the burner and the metal product may be varied to achieve a particular heating rate and/or temperature and the amount of fuel feed to the burner may be varied to achieve a particular heating rate and/or temperature. For a metal product in motion, the burners may include multiple series of burners spaced, positioned, and/or fed with appropriate amounts of fuel to achieve a desired heating rate and/or temperature distribution within the metal product.

It will be appreciated that many metals exhibit thermal conductivities that are of a sufficient value to allow heat added in a spatially non-uniform fashion to distribute quickly through a metal product and equalize the temperature throughout the metal product. To minimize the rate at which the temperature equalizes in the metal product upon spatially non-uniform introduction of heat or spatially non-uniform temperature control, cooling and/or quenching may be simultaneously and/or sequentially applied to a metal product. For example, quenching or cooling may be applied in a spatially non-uniform fashion to restrict heat from spreading to certain regions of a metal product at the same time as heat is applied to other regions of the metal product.

As a first example, spray nozzles may be used to apply cooling (i.e., removal of heat) in a spatially non-uniform fashion, such as where a series of individually actuatable liquid spray nozzles are used to apply cooling liquid (e.g., water) to a metal product to achieve a particular temperature distribution and/or cooling/quenching rate. In some embodiments, application of cooling liquid may be used to minimize the spread or distribution of heat applied by a heat source, which may allow for smaller regions of heat treatment application in order to achieve a particular non-uniform heat treatment application. In some embodiments, application of cooling liquid may be used to generate a non-uniform quench to the metal product. These aspects may be combined, such as where the distribution of heat applied in a non-uniform heat treatment is controlled by exposing a metal product to cooling liquid and where the metal product is further exposed to cooling liquid at the heated portions to also allow for control over the quench rate.

Spatially non-uniform cooling or quenching may be applied to a metal product using a variety of techniques and control parameters. For example, the quench/cooling rate may be controlled through control parameters such as the volume or flow rate of cooling liquid provided by a spray nozzle, a temperature of the cooling liquid provided by a spray nozzle, a composition of the cooling liquid provided by a spray nozzle, a position of a spray nozzle relative to the metal product, a number of spray nozzles, etc. In embodiments, each of these control parameters may be varied continuously and independently to allow for a particular cooling/quench profile to be achieved at a particular location in the metal product, and further independently over the spatial area of the metal product, to allow for continuously and independently variable spatially non-uniform cooling/quenching. Example cooling rates include, but are not limited to, those between about 50° C./s and about 1000° C./s. It will be appreciated that while spatially non-uniform quenching and cooling may be called out as distinct from heating applications in some instances, spatially non-uniform quenching, cooling, and heating techniques may also be referred to herein broadly under the umbrella phrases spatially non-uniform heating or spatially non-uniform heat treatment.

In some embodiments, thermoelectric cooling techniques are used for simultaneous and/or separate heating or cooling. For example, an array of thermoelectric cooling modules may be used to independently heat/cool different portions of a metal product, which may allow for precise spatial temperature control.

Spatially non-uniform heat treatment techniques may be applied individually to sections of a metal product, akin to a printing process, where a particular spatial heat treatment profile is applied to a metal product, such as a sheet metal blank, prior to forming the metal product in a stamping process, for example. Spatially non-uniform heat treatment techniques may be applied continuously to sections of a moving metal product, akin to a roll processing technique, where a particular spatial heat treatment profile is applied to a metal product as it is transported through a system, such as where sheet metal from a coil is roll processed by exposing sections of the sheet metal to a heat treatment. Optionally, a registration may be applied to the rolling sheet metal, such as a stencil, to allow for identification of the different heat treatments applied along the length of the rolling direction or perpendicular to the rolling direction, for example.

In some examples, the metal may comprise a composite structure, such as including a metal layer and a second layer, such as a second layer that includes one or more of a second metal layer, a fabric layer, a fiber layer, a carbon fiber layer, a polymer layer, a prepolymer layer, or a thermoset plastic layer. Methods and objects described herein may employ spatially non-uniform heat treatment on composite products to enhance the formability characteristics of the metal component of the composite product, while retaining other benefits, such as strength benefits, of the additional materials of the composite product.

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1 provides a schematic illustration of a metal product and plots showing example strength and formability profiles for a uniform metal product.

FIG. 2 provides a schematic illustration of a spatially non-uniformly heat treated metal product and plots showing example strength and formability profiles for the metal product.

FIG. 3 provides a schematic illustration of a spatially non-uniformly heat treated metal product and plots showing example strength and formability profiles for the metal product.

FIG. 4A, FIG. 4B, and FIG. 4C provide schematic illustrations of spatially non-uniform heat treatment of a metal product, showing three different example heat treatment profiles.

FIG. 5A provides a schematic illustration of a flame impingement heating technique for spatially non-uniformly heat treating a metal product. FIG. 5B provides a schematic illustration of a magnetic induction heating technique for spatially non-uniformly heat treating a metal product. FIG. 5C provides a schematic illustration of a spray quenching technique for spatially non-uniformly heat treating a metal product. FIG. 5D provides a schematic illustration of a thermoelectric cooling/heating technique for spatially non-uniformly heat treating a metal product.

FIG. 6 provides a schematic illustration of a continuous thermoelectric cooling/heating technique for spatially non-uniformly heat treating a moving metal product.

FIG. 7 provides a schematic illustration of a metal product subjected to a spatially non-uniform heat treatment process.

FIG. 8 provides a schematic overview of drawing of a metal sheet subjected to spatially non-uniform heat treatment.

### DETAILED DESCRIPTION

Described herein are methods for spatially non-uniformly heat treating metals, metals subjected to spatially non-uniform heat treatment, methods for forming metal products using spatially non-uniform heat treatment, and resultant metal products. Spatially non-uniform heat treatment may be useful for subjecting a metal product to any of a variety of treatments, including solution heat treatment, tempering, annealing, homogenizing, aging, etc. The disclosed methods may be particularly useful for solution heat treatment, tempering, or annealing in order to modify the strength and formability characteristics of the metal product. For example, spatially non-uniformly heat treated metal products may exhibit spatially non-uniform strength and/or forming properties, which may allow for improved stamping techniques. For example, some formed or stamped metal products may include regions of the metal product that are subjected to deep drawing. Such regions may benefit from high formability characteristics and reduced strength, while other regions of the metal product may benefit from high strength and reduced formability characteristics. The spatially non-uniform heat treatment, and resulting spatially non-uniform formability characteristics and spatially non-uniform strength characteristics, may extend over all or a portion of a metal product to allow different portions of the metal to behave differently during forming. In some embodiments, the spatially non-uniform heat treatment applied to a metal product may be engineered to allow a particular response of the metal product to a stamping process or another process, optionally following the stamping process, such as a paint-bake process.

Certain metal product, such as aluminum alloy products, may exhibit different strength and formability characteristics depending on the processing of the metal product. For example, work hardening may occur in certain alloys, resulting in higher strength but lower ductility and formability characteristics. For certain alloys, heating may restore ductility and formability characteristics, at the expense of strength. For other alloys, a carefully controlled heating and quenching or cooling profile may allow strengthening of the metal product, which may come at the expense of reduced formability characteristics. It may be beneficial, however, to maintain high strength in one section or region of a metal product, while allowing reduced strength or formability characteristics to occur in another section or region, which may be subjected to, for example, deep drawing during a stamping process. By applying spatially non-uniform heat treatment, the strength and formability characteristics of the metal product may be spatially engineered to simultaneously achieve high strength, where desired, and high formability characteristics, where desired.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference is made to alloys identified by AA numbers and other related designations, such as “series” or “7xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum alloy product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum alloy product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm).

Reference may be made in this application to alloy temper or condition. For an understanding of the alloy temper descriptions most commonly used, see “American National Standards (ANSI) H35 on Alloy and Temper Designation Systems.” An F condition or temper refers to an aluminum alloy as fabricated. An O condition or temper refers to an aluminum alloy after annealing. An Hxx condition or temper, also referred to herein as an H temper, refers to a non-heat treatable aluminum alloy after cold rolling with or without thermal treatment (e.g., annealing). Suitable H tempers include HX1, HX2, HX3 HX4, HX5, HX6, HX7, HX8, or HX9 tempers. A T1 condition or temper refers to an aluminum alloy cooled from hot working and naturally aged (e.g., at room temperature). A T2 condition or temper refers to an aluminum alloy cooled from hot working, cold worked and naturally aged. A T3 condition or temper refers to an aluminum alloy solution heat treated, cold worked, and naturally aged. A T4 condition or temper refers to an aluminum alloy solution heat treated and naturally aged. A T5 condition or temper refers to an aluminum alloy cooled from hot working and artificially aged (at elevated temperatures). A T6 condition or temper refers to an aluminum alloy solution heat treated and artificially aged. A T7 condition or temper refers to an aluminum alloy solution heat treated and artificially overaged. A T8x condition or temper refers to an aluminum alloy solution heat treated, cold worked, and artificially aged. A T9 condition or temper refers to an aluminum alloy solution heat treated, artificially aged, and cold worked. A W condition or temper refers to an aluminum alloy after solution heat treatment.

As used herein, terms such as “cast metal product,” “cast product,” “cast aluminum alloy product,” and the like are interchangeable and may refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As used herein, the meaning of “room temperature” can include a temperature of from about 15° C. to about 30° C., for example about 15° C., about 16° C., about 17° C., about 18 ° C., about 19° C., about 20° C., about 21° C., about 22° C., about 23° C., about 24° C., about 25° C., about 26° C., about 27° C., about 28° C., about 29° C., or about 30° C. As used herein, the meaning of “ambient conditions” can include temperatures of about room temperature, relative humidity of from about 20% to about 100%, and barometric pressure of from about 975 millibar (mbar) to about 1050 mbar. For example, relative humidity can be about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, or anywhere in between. For example, barometric pressure can be about 975 mbar, about 980 mbar, about 985 mbar, about 990 mbar, about 995 mbar, about 1000 mbar, about 1005 mbar, about 1010 mbar, about 1015 mbar, about 1020 mbar, about 1025 mbar, about 1030 mbar, about 1035 mbar, about 1040 mbar, about 1045 mbar, about 1050 mbar, or anywhere in between.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

Metal alloy products described herein may also be referred to as “metal substrates” or “metal products.” Example metal products may include rolled metal products, such as metal sheets, metal plates, metal shates, and other metal objects to which a nonuniform heat treatment can be applied according to aspects described herein. Treated metal substrates may be formed into other products, such as by one or more blanking, stamping, drawing, roll forming, or other mechanical processes.

As used herein, the meaning of “a,” “an,” and “the” includes singular and plural references unless the context clearly dictates otherwise.

As used herein, “and/or” means that one, all, or any combination of items in a list separated by “and/or” are included in the list; for example “A, B, and/or C” is equivalent to “‘A’, or ‘B’, or ‘C’, or ‘A and B’, or ‘A and C’, or ‘B and C’, or ‘A, B, and C’.”

Unavoidable impurities, including materials or elements, may be present in a metal or metal alloy, such as aluminum or an aluminum alloy, in minor amounts due to inherent properties of the metal or leaching from contact with processing equipment. Some impurities typically found in aluminum include iron and silicon. The alloy, as described, may contain no more than about 0.25 wt. % of any element besides the alloying elements, incidental elements, and unavoidable impurities.

### Methods of Producing the Metal and Metal Alloy Products

The metals, metal alloys, and metal alloy products described herein (e.g., metal substrates) can be cast using any suitable casting method known to those of ordinary skill in the art. As a few non-limiting examples, the casting process can include a Direct Chill (DC) casting process or a Continuous Casting (CC) process. The continuous casting system can include a pair of moving opposed casting surfaces (e.g., moving opposed belts, rolls, or blocks), a casting cavity between the pair of moving opposed casting surfaces, and a molten metal injector. The molten metal injector can have an end opening from which molten metal can exit the molten metal injector and be injected into the casting cavity.

A cast ingot or other cast product can be processed by any suitable means. Optionally, the processing steps can be used to prepare sheets. Such processing steps include, but are not limited to, homogenization, hot rolling, cold rolling, solution heat treatment, and an optional pre-aging step, as known to those of skill in the art.

In a homogenization step, a product as described herein, such as a cast metal product, is heated to a temperature ranging from about 400° C. to about 500° C. For example, the product can be heated to a temperature of about 400° C., about 410° C., about 420° C., about 430° C., about 440° C., about 450° C., about 460° C., about 470° C., about 480° C., about 490° C., or about 500° C. The product is then allowed to soak (i.e., held at the indicated temperature) for a period of time. In some examples, the total time for the homogenization step, including the heating and soaking phases, can be up to 24 hours. For example, the product can be heated up to 500° C. and soaked, for a total time of up to 18 hours for the homogenization step. Optionally, the product can be heated to below 490° C. and soaked, for a total time of greater than 18 hours for the homogenization step. In some cases, the homogenization step comprises multiple processes. In some non-limiting examples, the homogenization step includes heating the product to a first temperature for a first period of time followed by heating to a second temperature for a second period of time. For example, the product can be heated to about 465° C. for about 3.5 hours and then heated to about 480° C. for about 6 hours.

Following the homogenization step, a hot rolling step can be performed. Prior to the start of hot rolling, the homogenized product can be allowed to cool to a temperature between 300° C. to 450° C. For example, the homogenized product can be allowed to cool to a temperature of between 325° C. to 425° C. or from 350° C. to 400° C. The product can then be hot rolled at a temperature between 300° C. to 450° C. to generate a hot rolled plate, a hot rolled shate, or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between).

The plate, shate, or sheet can then be cold rolled using conventional cold rolling mills and technology into a sheet. The cold rolled sheet can have a gauge between about 0.5 to 10 mm, e.g., between about 0.7 to 6.5 mm. Optionally, the cold rolled sheet can have a gauge of 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm. The cold rolling can be performed to result in a final gauge thickness that represents a gauge reduction of up to 85% (e.g., up to 10%, up to 20%, up to 30%, up to 40%, up to 50%, up to 60%, up to 70%, up to 80%, or up to 85% reduction). Optionally, an interannealing step can be performed during the cold rolling step. The interannealing step can be performed at a temperature of from about 300° C. to about 450° C. (e.g., about 310° C., about 320° C., about 330° C., about 340° C., about 350° C., about 360° C., about 370° C., about 380° C., about 390° C., about 400° C., about 410° C., about 420° C., about 430° C., about 440° C., or about 450° C.). In some cases, the interannealing step comprises multiple processes. In some non-limiting examples, the interannealing step includes heating the plate, shate or sheet to a first temperature for a first period of time followed by heating to a second temperature for a second period of time. For example, the plate, shate, or sheet can be heated to about 410° C. for about 1 hour and then heated to about 330° C. for about 2 hours.

Subsequently, the plate, shate, or sheet can undergo a solution heat treatment step. The solution heat treatment step can be any conventional treatment for the sheet which results in solutionizing of the soluble particles. The plate, shate, or sheet can be heated to a peak metal temperature (PMT) of up to 590° C. (e.g., from 400° C. to 590° C.) and soaked for a period of time at the temperature. For example, the plate, shate, or sheet can be soaked at 480° C. for a soak time of up to 30 minutes (e.g., 0 seconds, 60 seconds, 75 seconds, 90 seconds, 5 minutes, 10 minutes, 20 minutes, 25 minutes, or 30 minutes). After heating and soaking, the plate, shate, or sheet is rapidly cooled at rates greater than 200° C./s to a temperature between 500 and 200° C. In one example, the plate, shate, or sheet has a quench rate of above 200° C./second at temperatures between 450° C. and 200° C. Optionally, the cooling rates can be faster.

After quenching, the plate, shate, or sheet can optionally undergo a pre-aging treatment by reheating the plate, shate, or sheet before coiling. The pre-aging treatment can be performed at a temperature of from about 70° C. to about 125° C. for a period of time of up to 6 hours. For example, the pre-aging treatment can be performed at a temperature of about 70° C., about 75° C., about 80° C., about 85° C., about 90° C., about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours. The pre-aging treatment can be carried out by passing the plate, shate or sheet through a heating device, such as a device that emits radiant heat, convective heat, induction heat, infrared heat, or the like.

### Methods of Using the Disclosed Metals and Metal Alloy Products

The metal and metal alloy products described herein can be used in automotive applications and other transportation applications, including aircraft and railway applications, or any other desired application. For example, disclosed aluminum alloy products can be used to prepare automotive structural parts, such as bumpers, side beams, roof beams, cross beams, pillar reinforcements (e.g., A-pillars, B-pillars, and C-pillars), inner panels, outer panels, side panels, inner hoods, outer hoods, or trunk lid panels. The aluminum alloy products and methods described herein can also be used in aircraft or railway vehicle applications, to prepare, for example, external and internal panels.

The disclosed metal and metal alloy products and associated methods described herein can also be used in electronics applications. For example, the aluminum alloy products and methods described herein can be used to prepare housings for electronic devices, including mobile phones and tablet computers. In some examples, the aluminum alloy products can be used to prepare housings for the outer casing of mobile phones (e.g., smart phones), tablet bottom chassis, and other portable electronics. The disclosed metal and metal alloy products and substrates and associated methods described herein can also be used in other applications.

### Methods of Treating Metals and Metal Alloys

Described herein are methods of treating metal and metal alloy products, including aluminum, aluminum alloys, magnesium, magnesium alloys, magnesium composites, and steel, among others, and the resultant treated metal and metal alloys products. In some examples, the metals for use in the methods described herein include aluminum alloys, for example, 1xxx series aluminum alloys, 2xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys. In some examples, the materials and products for use in the methods described herein include non-ferrous materials, including aluminum, aluminum alloys, magnesium, magnesium-based materials, magnesium alloys, magnesium composites, titanium, titanium-based materials, titanium alloys, copper, copper-based materials, composites, sheets or layers used in composites, or any other suitable metal, non-metal or combination of materials. Monolithic as well as non-monolithic, such as roll-bonded materials, cladded alloys, clad layers, composite materials, such as but not limited to carbon fiber-containing materials, or various other materials are also useful with the methods described herein. In some examples, aluminum alloys containing iron are useful with the methods described herein.

By way of non-limiting examples, exemplary AA1xxx series aluminum alloys for use in the methods described herein can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

Non-limiting exemplary AA2xxx series aluminum alloys for use in the methods described herein can include AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary AA3xxx series aluminum alloys for use in the methods described herein can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary AA4xxx series aluminum alloys for use in the methods described herein can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Non-limiting exemplary AA5xxx series aluminum alloys for use in the methods described herein can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary AA6xxx series aluminum alloys for use in the methods described herein can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, AA6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary AA7xxx series aluminum alloys for use in the methods described herein can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, 7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

In certain metals and metal alloys, strength and formability may be inversely related to one another and increasing one property may decrease the other. It is common in the sheet metal industry to provide a product with uniform or substantially uniform properties. Such a configuration can allow for reliability of use of the sheet metal, such as in a stamping or drawing process. Some metals or metal alloys may be desirable for their strength characteristics, while other metals or metal alloys may be desirable for their formability characteristics. It will be appreciated that heating and/or working metals may modify these properties.

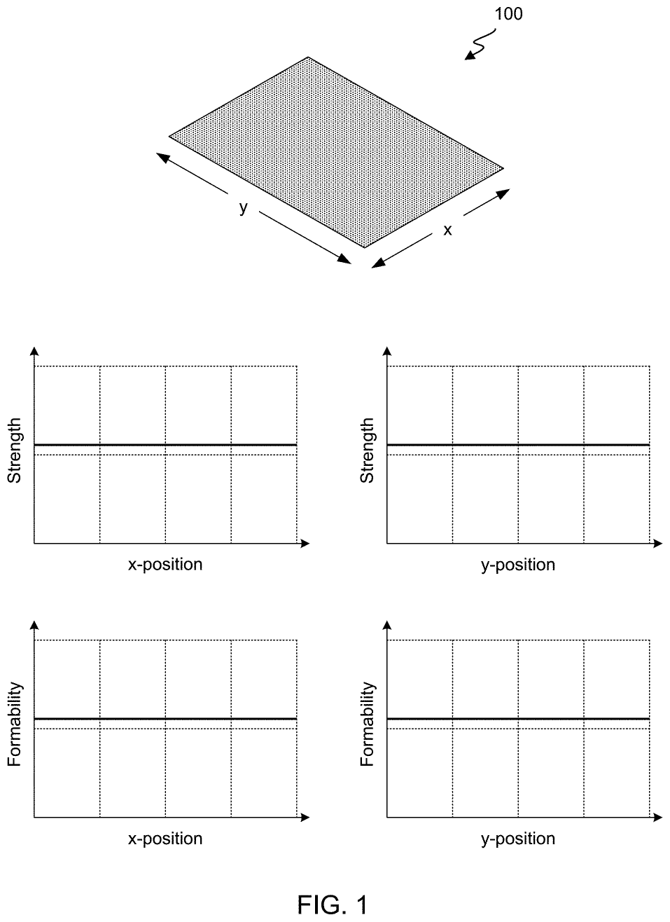

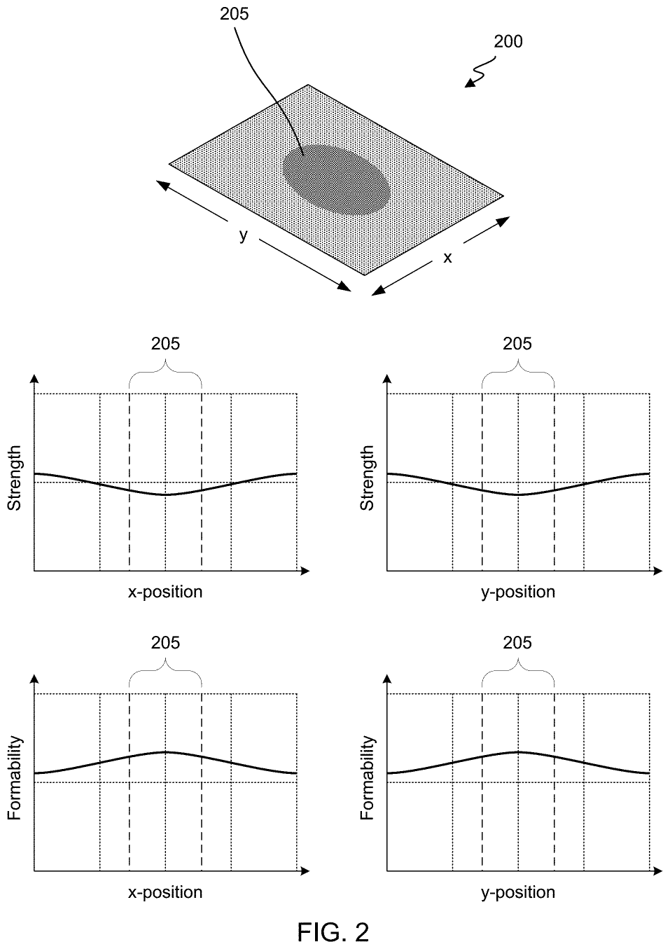

FIG. 1 provides a schematic illustration of a metal product 100, such as a sheet metal product, with plots showing how its strength and formability characteristics are uniform over the area of the metal product. As a metal product is heated, its formability may increase, while its strength may decrease. FIG. 2 provides a schematic illustration of a metal product 200, such as a sheet metal product, that has been subjected to heating in a middle region 205 of the metal product 200. Many metals exhibit high thermal conductivity, and so application of heat to a metal product may not necessarily result in precisely localized heating. Thermal diffusion may allow the heat to spread rapidly through the metal product. Plots are shown in FIG. 2 to illustrate how the heat may spread beyond middle region 205 and impact the strength and formability characteristics of the metal product beyond the middle region 205, reflecting a change from FIG. 1.

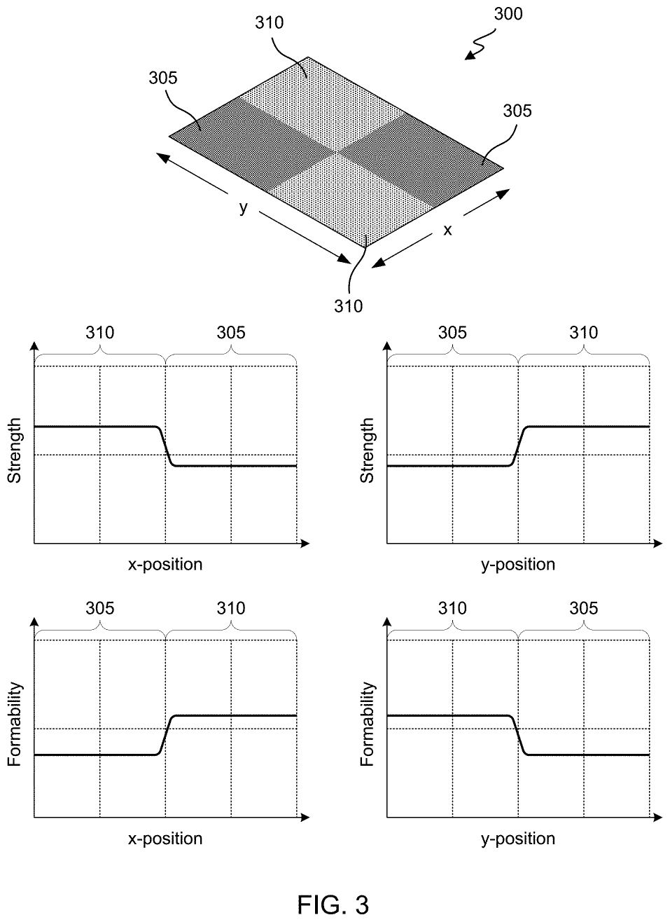

The present disclosure allows for control and creation of more complex formability characteristics and strength distributions over the area of the metal product. For example, by heat treating different sections of a metal product and carefully controlling the temperature distribution, the strength and formability characteristics can be controlled to provide a spatially variable product. For example, FIG. 3 provides a schematic illustration of a metal product 300 in which different portions have been subjected to different heat treatments, resulting in modification of the strength and formability characteristics, as depicted by the plots in FIG. 3. For example, regions 305 may correspond to portions that are heated, while regions 310 may correspond to regions that are cooled.

Metal product 100, 200, and 300 depicted in FIGS. 1-3 may correspond to a sheet metal blank or a section of a sheet metal coil, for example. Other thicknesses of metal product (e.g., shate or plate) may be considered in the same way as sheet metal in FIGS. 1-3, and these product may further more easily exhibit non-uniformity along a third dimension (e.g., thickness dimension) than a metal sheet, which may be limited in non-uniformity in the thickness direction due to the rate of thermal conduction along the thickness dimension of the metal sheet.

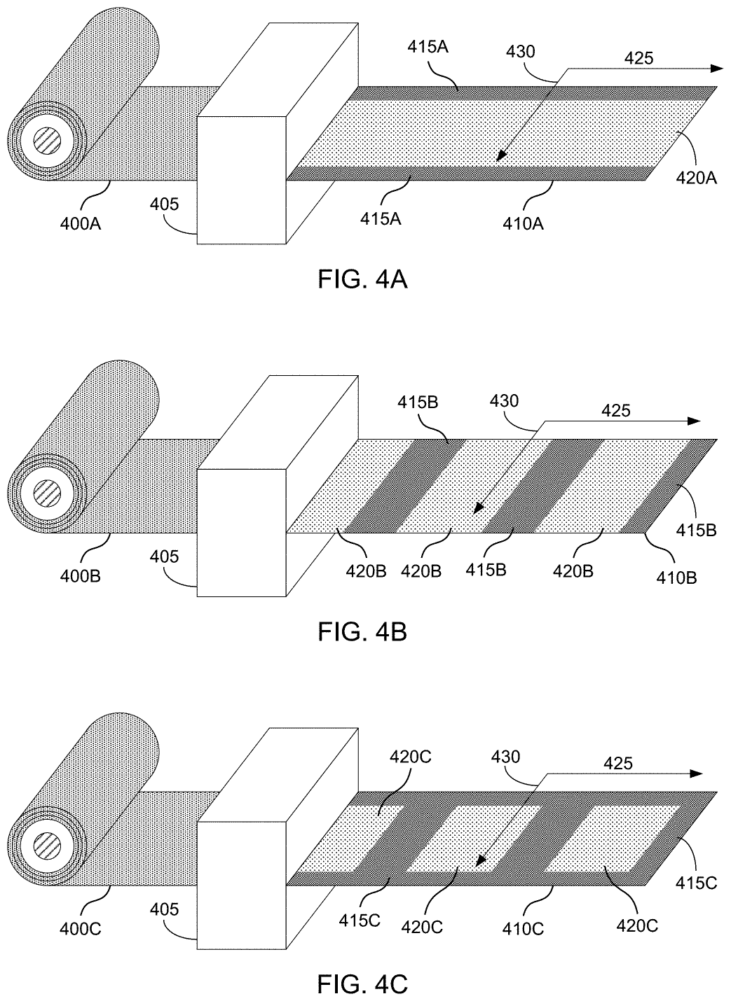

In general, however, strength and/or formability character in the metal product may exhibit any desirable distribution. In rolled metal products, this may correspond to, at least, variability in the rolling direction and/or the transverse direction (i.e., perpendicular to rolling direction). In some embodiments, the non-uniform heat treatment may be applied only in the transverse direction. FIG. 4A provides a schematic illustration of heat treating a rolled metal product 400A uniformly along the rolling direction 425 and non-uniformly along a transverse direction 430, such as in a roll-to-roll processing method or as part of a rolling process. Here, rolled metal product 400A, which may correspond to sheet metal, for example, is subjected to a non-uniform heat treatment at heating system 405. Heating system 405 may apply any suitable heat treatment, including heating, quenching, and/or cooling, to rolled metal product 400A to generate a heat treated rolled metal product 410A. As illustrated, heat treated rolled metal product 410A exhibits two different heat treatment areas, 415A and 420A, which correspond to edges and a middle, respectively, of heat treated rolled metal product 410A.

In some embodiments, the heat treatment may be applied non-uniformly only along the rolling direction, while heat treatment may be applied uniformly along a transverse direction. FIG. 4B provides a schematic illustration of non-uniformly heat treating a rolled metal product 400B only along rolling direction 425. Here rolled metal product 400B is subjected to a non-uniform heat treatment at heating system 405. As illustrated, heat treated rolled metal product 410B exhibits two different heat treatment areas, 415B and 420B, which correspond to different sections along the rolling direction of heat treated rolled metal product 410B. To allow for identification of the different areas (e.g., areas 415B and 420B) along the rolling direction, a heat treated rolled metal product (e.g., heat treated rolled metal product 410B) may optionally be subjected to a stenciling process, such as where registration notations are inked onto the surface of the heat treated rolled metal product, which may identify breaks or transitions between the different heat treatment areas, such as between the repeated pairs of areas 415B and 420B, for example.

In some embodiments, the non-uniform heat treatment may be applied along both the rolling 425 and the transverse 430 directions. FIG. 4C provides a schematic illustration of non-uniformly heat treating a rolled metal product 400C. Here rolled metal product 400C is subjected to a non-uniform heat treatment at heating system 405. As illustrated, heat treated rolled metal product 410C exhibits two different heat treatment areas, 415C and 420C. Heat treatment area 420C may, for example, correspond to a middle of an area, surrounded by heat treatment area 415C, which may correspond to edges and spacing sections of heat treated rolled metal product 410A areas 420C. Again, stenciling may optionally be used to provide registration and notation of relevant areas of interest.

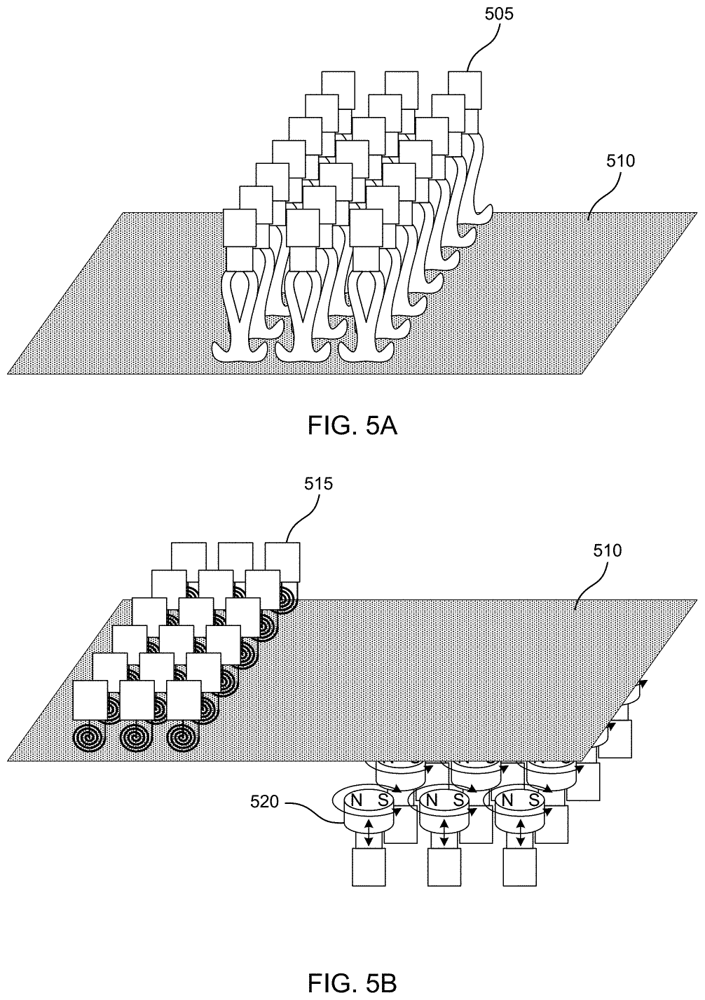

Although only two distinct heat treated areas are illustrated in FIGS. 4A-4C, it will be appreciated that any suitable number or spatial variability of separately heat treated sections may be implemented and that the heat treatment along the transverse 430 and rolling directions 425 may be discretely or continuously non-uniform. As used herein, discretely non-uniform heat treatment may refer to a heat treatment that abruptly changes over a particular distance (e.g., mm or cm), such as depicted in FIG. 3. As used herein, continuously non-uniform heat treatment may refer to a heat treatment that is smoothly variable over a particular distance, such as depicted in FIG. 2. Example heat treatment techniques applied by heating system 405 are described below with reference to FIGS. 5A-5D.

FIG. 5A provides a schematic illustration of a technique for spatially non-uniform heat treatment using flame impingement. In FIG. 5A, a series of fuel burners 505 are distributed across a region of a metal substrate 510. Each fuel burner 505 may independently burn a controllable amount of fuel and/or may be independently positioned at a distance above metal product 510 in order to establish a desired non-uniform temperature profile within the metal product 510. In some embodiments, metal product 510 may be in motion, similar to the configuration depicted in FIGS. 4A-4C, where the metal is transported along rolling direction 425. This may allow for application of heat for a particular time duration, as a section of the metal product may only be exposed to a particular burner 505 for the amount of time necessary for the metal product to move past the particular burner 505. In other embodiments, metal product 510 may be stationary (e.g., processing of a sheet metal blank or batch processing of a length of sheet metal) and so the duration of burning fuel may be useful for application of heat for a particular time duration. Controlling the speed of the metal product, duration of burning of fuel, position of burner above the metal product, amount/rate of fuel provided to the burner, etc. may each independently provide useful ways to control the temperature and/or heat treatment profile of metal product 510. Although only 3 rows of 7 burners 505 are depicted in FIG. 5A, any desirable number, groups, and arrangement of burners may be applied in a flame impingement technique for spatially non-uniform heat treatment of a metal product, including arrangements where burners are not present in some locations or are not actuated or activated in some locations. Further, a flame impingement technique may be used alone or in combination with another heat treatment technique to achieve a desired spatially non-uniform heat treatment. For example, arrays including different heating and/or cooling devices interspersed amongst one another may be used.

FIG. 5B provides a schematic illustration of a technique for spatially non-uniform heat treatment using magnetic (electromagnetic) induction. In FIG. 5B, a series of electromagnetic coils 515 are distributed across a region of a metal substrate 510. Each electromagnetic coil 515 may be independently energized using a high frequency alternating current applied to create a rotating magnetic field and induce eddy currents in metal product 510 and heat metal product 510. FIG. 5B also shows a series of rotatable permanent magnets 520 distributed across a region of a metal product 510. Each rotatable permanent magnet 520 may be independently rotated at different speeds to create a rotating magnetic field and induce eddy currents in metal product 510 and heat metal product 510. In some embodiments, metal product 510 may be in motion, similar to the configuration depicted in FIGS. 4A-4C, where the metal product is transported along rolling direction 425. This may allow for application of heat for a particular time duration, as a section of the metal product may only be exposed to a rotating magnetic field from a particular electromagnetic coil 515 and/or rotatable permanent magnet 520 for the amount of time necessary for the metal product to move past. In other embodiments, metal product 510 may be stationary (e.g., processing of a sheet metal blank or batch processing of a length of sheet metal) and so the duration of application a rotating magnetic field may be controlled by the duration of application of AC voltage to an electromagnetic coil 515 or duration of rotation of rotatable permanent magnet 520 may be useful for application of heat for a particular time duration. Controlling the speed of the metal product, duration of the application of a rotating magnetic field, speed of rotation of the magnetic field (either through frequency of AC voltage applied to electromagnetic coil 515 or physical rotation of or rotatable permanent magnet), position of the electromagnetic coil 515 or rotatable permanent magnet 520 above metal substrate 510, gap spacing between adjacent magnetic sources (electromagnetic coils 515 and/or rotatable permanent magnets 520), the magnitude of the AC voltage applied to electromagnetic coil 515, etc. may independently each provide useful ways to control the temperature and/or heat treatment profile of metal product 510. As an example, the smaller a gap between pairs of magnetic sources, the higher the heating rate may be. It will be appreciated that, although only 3 rows of 6 electromagnetic coils 515 and 3 rows of 4 rotatable magnets 520 are depicted in FIG. 5B, any desirable number or groups of electromagnetic coils and/or rotatable permanent magnets may be applied in a magnetic induction technique for spatially non-uniform heat treatment of a metal product, including arrangements where electromagnetic coils and/or rotatable permanent magnets are not present in some locations or are not actuated or activated in some locations. Further, a magnetic induction technique may be used alone or in combination with another heat treatment technique to achieve a desired spatially non-uniform heat treatment.

FIG. 5C provides a schematic illustration of a technique for spatially non-uniform heat treatment using exposure to a fluid (e.g., liquids, such as water, an aqueous solution, or an oil, or gasses, such as air, nitrogen, or argon, etc.). In FIG. 5C, a series of nozzles 525 are distributed across a region of a metal product 510. Each nozzle 525 may be independently actuated to expose metal product 510 to a fluid. The compositions of the fluids from each nozzle 525 may be independent. The temperatures of the fluids from each nozzle 525 may be independent. The flow rates of the fluids from each nozzle 525 may be independent. If metal product 510 is heated, the process of exposing metal product 510 to a liquid may be referred to as quenching, which may allow the temperature of all or portions of metal product 510 to be rapidly reduced. Control over the quench rate and temperature profile during quenching may be useful for controlling formability character and/or strength in the metal product 510. In some embodiments, metal product 510 may be in motion, similar to the configuration depicted in FIGS. 4A-4C, where the metal product is transported along rolling direction 425. This may allow for application of fluid for a particular time duration, as a section of the metal product may only be exposed to fluid from a particular nozzle 525 for the amount of time necessary for the metal product to move past the nozzle. In other embodiments, metal product 510 may be stationary (e.g., processing of a sheet metal blank or batch processing of a length of sheet metal) and so the duration of application fluid may be controlled by the duration of exposure or sequences of exposure of fluids from different nozzles 525 may be useful to achieve a particular heat treatment for a particular time duration. Controlling the speed of the metal product, duration of the exposure to the fluid, composition of the fluid, temperature of the fluid, flow rate of the fluid, position of nozzle 525, etc. may each provide useful ways to control the temperature and/or heat treatment profile of metal product 510. It will be appreciated that, although only 3 rows of 7 nozzles 525 are depicted in FIG. 5C, any desirable number or groups of nozzles may be applied in a fluid treatment technique for spatially non-uniform heat treatment of a metal product, including arrangements where nozzles are not present in some locations or are not actuated or activated in some locations. Further, a fluid treatment technique may be used alone or in combination with another heat treatment technique to achieve a desired spatially non-uniform heat treatment.

In some embodiments, heat may be applied to a portion of a metal product at the same time that heat is removed from another portion of a metal product. Such a combined heat addition/heat removal technique may advantageously provide for localization of a particular heat treatment profile and minimize the effects of thermal diffusion. It will be appreciated that the rate of thermal diffusion of many metals may be very high, as metals commonly have large thermal conductivities (e.g., greater than about 10 W/m·K). In order to prevent heat added to one region of a metal product from quickly transporting to another region of the metal product, at least a portion of the heat may be removed at an adjacent position. Metal products may be heated, for example, using the above disclosed techniques and may have heat removed by exposure to a fluid, such as oil, water, or a gas.

Other heating or cooling elements may be used to control the introduction of heat or removal of heat from a metal product, without limitations. In some embodiments, thermoelectric heat pumps may be employed for spatially non-uniform heat treatment of metal product. Thermoelectric heat pumps correspond to solid state devices employing the Peltier effect for transporting heat across a junction between two metals in the thermoelectric heat pump. Depending on the direction of current flow in the thermoelectric heat pump, heat may be transported in opposite directions, allowing the same device to function to add heat or remove heat. Such a device provides flexibility for heat treatment, as a single device can be used both for heating and cooling purposes. FIG. 5D provides a schematic illustration of an array of thermoelectric heat pumps 530 being used for heat treatment of a metal product 510. Each individual thermoelectric heat pump 530 in FIG. 5D is illustrated as including individual heat sinks in order to provide or dissipate heat into or from metal product 510. In some embodiments, a common heat sink may be provided such that heat from/to an individual thermoelectric heat pump 530 is provided to/from the common heat sink. Such a configuration may provide benefits for situations where thermoelectric heat pumps for cooling are adjacent to thermoelectric heat pumps for heating. Controlling the direction and magnitude of current flow to the thermoelectric heat pumps 530, duration of the contact between thermoelectric heat pumps 530 and metal product 510 (e.g., by raising/lowering thermoelectric heat pumps 530 relative to metal product 510), etc. may each provide useful ways to control the temperature and/or heat treatment profile of metal product 510. It will be appreciated that, although only 6 rows of 6 thermoelectric heat pumps 530 are depicted in FIG. 5D, any desirable number or groups of thermoelectric heat pumps may be used for spatially non-uniform heat treatment of a metal product, including arrangements where thermoelectric heat pumps are not present in some locations or are not actuated or activated in some locations. Further, a thermoelectric heat pump-based technique may be used alone or in combination with another heat treatment technique to achieve a desired spatially non-uniform heat treatment.

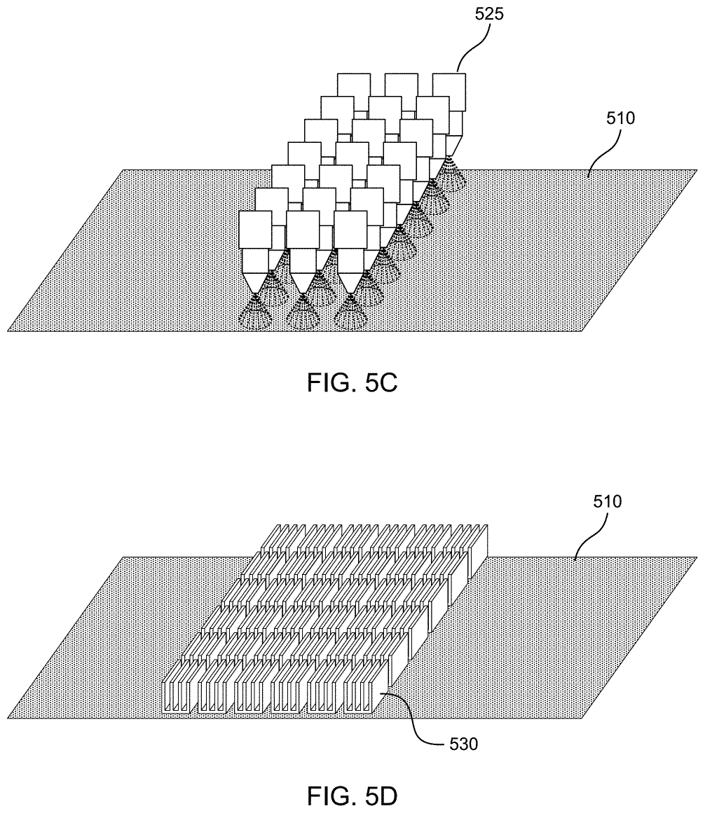

FIG. 6 provides another configuration for using thermoelectric heat pumps for heat treatment of a metal product 600. Here, an array of thermoelectric heat pumps 605 is provided as part of a conveyor 610, which may be useful for allowing sufficient time for contact between metal product 600 and thermoelectric heat pumps 605 to allow for suitable heat treatment when metal product 600 is in motion along direction 615. Advantageously, such a configuration may allow for “printing” a desired heat treatment directly on metal product 600 using a conveyor system in-line with other roll-processing equipment. Although thermoelectric heat pumps 605 are provided as part of conveyor 610 in FIG. 6, this configuration is not intended to be limiting, and other configurations are contemplated and may be used in place of conveyor 600, such as a roller including an array of thermoelectric heat pumps and a movable platform including an array of thermoelectric heat pumps. In each configuration, however, the contact duration may be of a sufficient time to allow for suitable heat treatment. In FIG. 6, the heat treatment applied to metal product 600 by thermoelectric heat pumps 605 is illustrated as including three different levels of heat treatment (e.g., at the edges of metal substrate 600), as well as no heat treatment (e.g., in the middle of metal substrate 600), such as to produce a spatially non-uniform heat treatment along rolling direction 615 and transverse direction 620, similar to the configuration illustrated in FIG. 4C. Such a configuration where edges and the middle of a metal product receive different heat treatments may be useful for various embodiments, such as where edges of a metal sheet may be hemmed and benefit from increased formability character relative to other portions of the metal sheet.

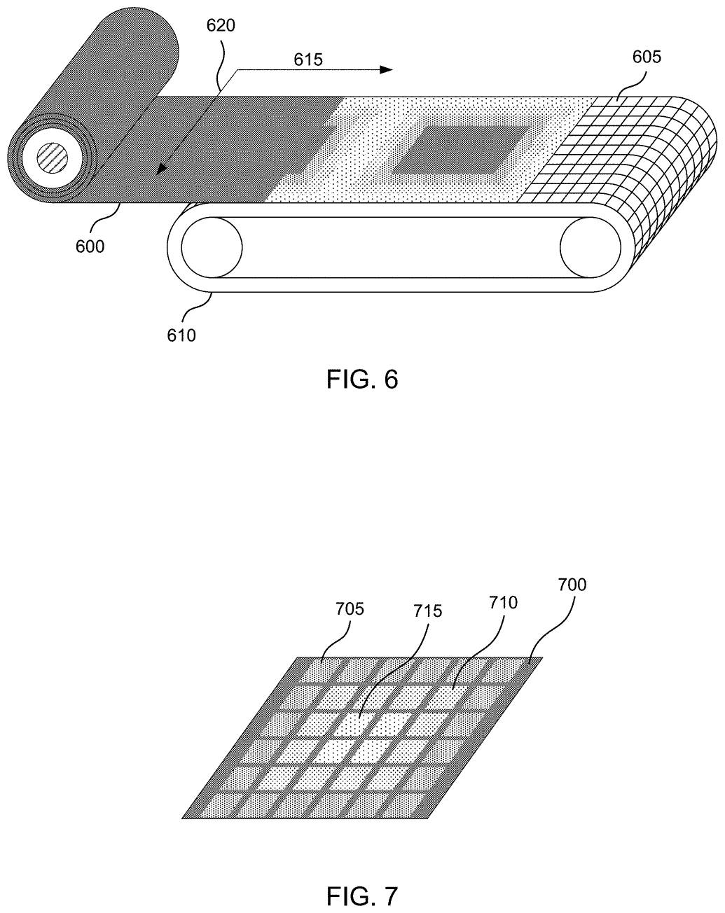

FIG. 7 provides a schematic illustration of an example metal product 700 after heat treatment, such as by using any of the heat treatment techniques depicted in FIGS. 4A-4C, 5A-5D, or 6. Metal product 700 is illustrated as having individual portions of metal represented with three different levels of heat treatments (705, 710, and 715). Heat treatments 705, 710, and 715 may represent application of heat or removal of heat using any particular means and is intended to represent different heat treatments, generally, including combinations of different heating, cooling, or quenching techniques. For example, heat treatment 705 may represent heating or cooling/quenching, heat treatment 710 may represent the same or different heating or cooling/quenching, and heat treatment 715 may represent a further same or different heating or cooling/quenching. Although heat treatments 705, 710, and 715 in FIG. 7 are illustrated as spaced apart with non-heat treated regions of metal product 700 between them, the different heat treatment regions may optionally abut or even overlap one another in some embodiments. It will also be appreciated that, although heat-treated regions of metal product 700 are depicted as rectangular or square in shape, any suitable shapes may be used and may be dictated by the heating/cooling/quenching source shape, position, spacing, etc., the heat conductivity of metal product 700, a duration of heat/cooling/quenching application during a heat treatment process, etc.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. During the studies described in the following examples, conventional procedures were followed, unless otherwise stated. Some of the procedures are described below for illustrative purposes.

### EXAMPLE A

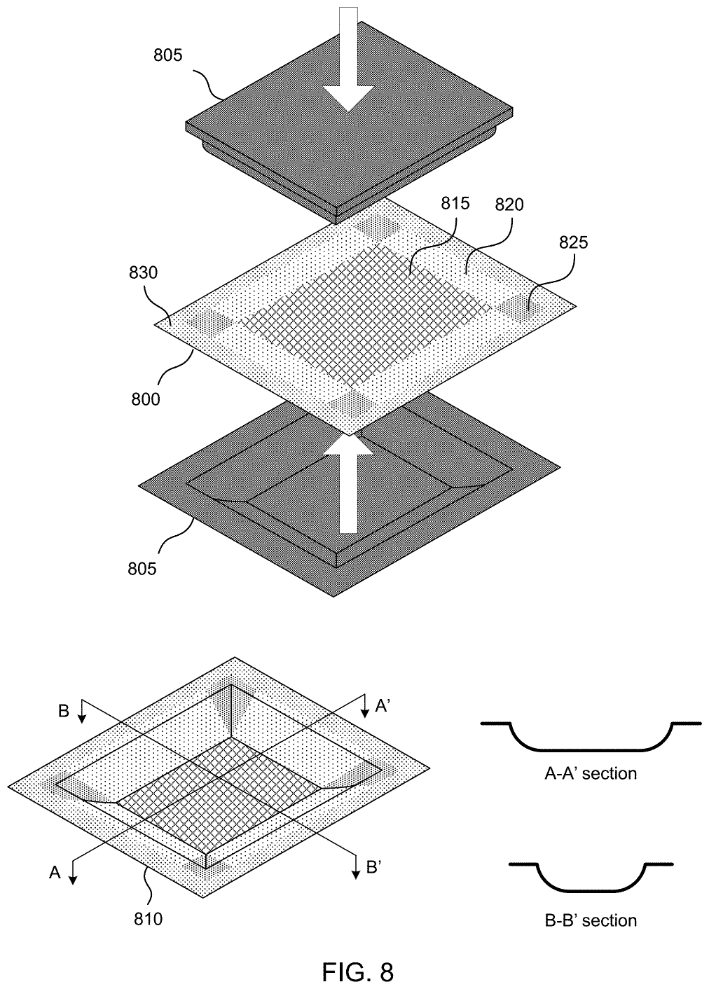

FIG. 8 provides an overview of drawing a sheet metal blank to form a stamped product using a die. As illustrated, sheet metal blank 800 corresponds to a sheet metal blank that has been subjected to a spatially non-uniform heat treatment. As the components of die 805 come together, as indicated by the arrows in FIG. 8, the sheet metal blank 800 is drawn to form stamped metal product 810.

Here, die 805 exhibits a non-planar profile and different strain levels are to be imparted on the sheet metal blank 800 at several different regions. Thus, sheet metal blank 800 may benefit from having different strength and/or formability characteristics at different regions and so may be heat treated accordingly. For example, sheet metal blank may be heat treated (or be untreated) to have relatively high strength and low formability characteristics in middle region 815 and more formability in side regions 820 and corner regions 825. Depending on the strain imparted during stamping, corner regions 825 may benefit from having higher formability characteristics than side regions 820. Further, edge region 830 may be subjected to hemming and require a further different optimal or desirable strength/formability character. Upon stamping, the profile of die 805 is formed into sheet metal blank 800 in a drawing process. By providing a spatially non-uniform heat treatment to sheet metal blank 800, a precise formability character and strength arrangement may be provided to sheet metal blank 800. This may advantageously improve the stamping process and result in fewer defects or unsuitable stamped metal products 810.

### Illustrations

As used below, any reference to a series of illustrations is to be understood as a reference to each of those examples disjunctively (e.g., “Illustrations 1-4” is to be understood as “Illustrations 1, 2, 3, or 4”).

Illustration 1 is a method, comprising: subjecting a metal substrate to a spatially non-uniform heat treatment process to generate a heat treated metal product having a custom spatially non-uniform strength profile and a custom spatially non-uniform formability profile, wherein the spatially non-uniform heat treatment process includes heating or cooling different regions of the metal product using an array of heating, cooling, and/or quenching elements.

Illustration 2 is the method of any of the preceding or subsequent illustrations, wherein the spatially non-uniform heat treatment process includes heating a first region of the metal product to achieve a first temperature profile in the first region of the metal product and heating a second region of the metal product to achieve a second temperature profile in the second region of the metal product.

Illustration 3 is the method of any of the preceding or subsequent illustrations, wherein the spatially non-uniform heat treatment process includes cooling a first region of the metal product to achieve a first temperature profile in the first region of the metal product and cooling a second region of the metal product to achieve a second temperature profile in the second region of the metal product.

Illustration 4 is the method of any of the preceding or subsequent illustrations 3, wherein the spatially non-uniform heat treatment process includes heating a first region of the metal product to achieve a first temperature profile in the first region of the metal product and cooling a second region of the metal product to achieve a second temperature profile in the second region of the metal product.

Illustration 5 is the method of any of the preceding or subsequent illustrations, wherein the spatially non-uniform heat treatment process includes quenching a first region of the metal product according to a first quench profile and quenching a second region of the metal product according to a second quench profile.

Illustration 6 is the method of any of the preceding or subsequent illustrations, wherein the spatially non-uniform heat treatment process includes heating, cooling, and/or quenching the metal product using a direct flame impingement process, a magnetic or electromagnetic induction process, a spray cooling or spray quenching process, a thermoelectric heating process, a thermoelectric cooling process, or any combination of these.

Illustration 7 is the method of any of the preceding or subsequent illustrations, wherein the spatially non-uniform heat treatment process includes heating or cooling different regions of the metal product using a one-dimensional array of heating, cooling, and/or quenching elements.

Illustration 8 is the method of any of the preceding or subsequent illustrations, wherein the spatially non-uniform heat treatment process includes heating or cooling different regions of the metal product using a two-dimensional array of heating, cooling, and/or quenching elements.

Illustration 9 is the method of any of the preceding or subsequent illustrations, wherein the metal product comprises a sheet metal blank.

Illustration 10 is the method of any of the preceding or subsequent illustrations, wherein the metal product comprises at least a portion of a metal coil.

Illustration 11 is the method of any of the preceding or subsequent illustrations, wherein the metal product is in motion.

Illustration 12 is the method of any of the preceding or subsequent illustrations, wherein the metal product comprises a composite product including a metal layer and a second layer, wherein the second layer includes one or more of a second metal layer, a fabric layer, a fiber layer, a carbon fiber layer, a polymer layer, a prepolymer layer, or a thermoset plastic layer.

Illustration 13 is the method of any of the preceding or subsequent illustrations, further comprising stamping the heat treated metal product using a die.

Illustration 14 is the method of any of the preceding or subsequent illustrations, wherein the custom spatially non-uniform strength profile and the custom spatially non-uniform formability profile are selected to reduce defects imparted in the metal product upon subjecting the metal product to a stamping or drawing process.

Illustration 15 is a metal product comprising: a heat treated metal product having a spatially non-uniform strength profile and a spatially non-uniform formability profile, created by treating a metal product with a spatially non-uniform heat treatment, wherein the spatially non-uniform heat treatment process includes heating or cooling different regions of the metal product using an array of heating, cooling, and/or quenching elements.

Illustration 16 is the metal product of any of the preceding or subsequent illustrations, wherein treating the metal product with a spatially non-uniform heat treatment includes heating a first region of the metal product to achieve a first temperature profile in the first region of the metal product and heating a second region of the metal product to achieve a second temperature profile in the second region of the metal product.

Illustration 17 is the metal product of any of the preceding or subsequent illustrations, wherein treating the metal product with a spatially non-uniform heat treatment includes cooling a first region of the metal product to achieve a first temperature profile in the first region of the metal product and cooling a second region of the metal product to achieve a second temperature profile in the second region of the metal product.

Illustration 18 is the metal product of any of the preceding or subsequent illustrations, wherein treating the metal product with a spatially non-uniform heat treatment includes heating a first region of the metal product to achieve a first temperature profile in the first region of the metal product and cooling a second region of the metal product to achieve a second temperature profile in the second region of the metal product.

Illustration 19 is the metal product of any of the preceding or subsequent illustrations, wherein treating the metal product with a spatially non-uniform heat treatment includes quenching a first region of the metal product according to a first quench profile and quenching a second region of the metal product according to a second quench profile.

Illustration 20 is the metal product of any of the preceding or subsequent illustrations, wherein treating the metal product with a spatially non-uniform heat treatment includes heating, cooling, and/or quenching the metal product using a direct flame impingement process, a magnetic or electromagnetic induction process, a spray cooling or spray quenching process, a thermoelectric heating process, a thermoelectric cooling process, or any combination of these.

Illustration 21 is the metal product of any of the preceding or subsequent illustrations, wherein the spatially non-uniform heat treatment process includes heating or cooling different regions of the metal product using a one-dimensional array of heating, cooling, and/or quenching elements.

Illustration 22 is the metal product of any of the preceding or subsequent illustrations, wherein the spatially non-uniform heat treatment process includes heating or cooling different regions of the metal product using a two-dimensional array of heating, cooling, and/or quenching elements.

Illustration 23 is the metal product of any of the preceding or subsequent illustrations, wherein the metal product comprises a sheet metal blank.

Illustration 24 is the metal product of any of the preceding or subsequent illustrations, wherein the metal product comprises at least a portion of a metal coil.

Illustration 25 is the metal product of any of the preceding or subsequent illustrations, wherein the metal product comprises a composite product including a metal layer and a second layer, wherein the second layer includes one or more of a second metal layer, a fabric layer, a fiber layer, a carbon fiber layer, a polymer layer, a prepolymer layer, or a thermoset plastic layer.

Illustration 26 is the metal product of any of the preceding or subsequent illustrations wherein treating the metal product with a spatially non-uniform heat treatment includes treating the metal product while in motion.

Illustration 27 is the metal product of any of the preceding or subsequent illustrations, corresponding to a stamped metal product formed by stamping the heat treated metal product using a die.

Illustration 28 is the metal product of any of the preceding or subsequent illustrations, wherein the custom spatially non-uniform strength profile and the custom spatially non-uniform formability profile are selected to reduce defects imparted in the metal product upon subjecting the metal product to a stamping or drawing process.

Illustration 29 is the metal product or method of any of the preceding or subsequent illustrations, wherein the metal product is an aluminum alloy product.

Illustration 30 is the metal product or method of any of the preceding or subsequent illustrations, wherein the metal product is a rolled metal product.

Illustration 31 is the metal product or method of any of the preceding illustrations, wherein the metal product is sheet metal.

All patents, publications and abstracts cited above are incorporated herein by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

What is claimed is:

1. A method, comprising:
subjecting a metal product to a spatially non-uniform heat treatment process to generate a heat treated metal product having a custom spatially non-uniform strength profile and a custom spatially non-uniform formability profile, wherein the spatially non-uniform heat treatment process comprises heating or cooling different regions of the metal product using an array of heating elements, cooling elements, quenching elements, or any combination of these.

2. The method of claim 1, wherein the spatially non-uniform heat treatment process comprises heating a first region of the metal product to achieve a first temperature profile in the first region of the metal product and heating a second region of the metal product to achieve a second temperature profile in the second region of the metal product that is different from the first temperature profile.

3. The method of claim 1, wherein the spatially non-uniform heat treatment process comprises cooling a first region of the metal product to achieve a first temperature profile in the first region of the metal product and cooling a second region of the metal product to achieve a second temperature profile in the second region of the metal product that is different from the first temperature profile.

4. The method of claim 1, wherein the spatially non-uniform heat treatment process comprises heating a first region of the metal product to achieve a first temperature profile in the first region of the metal product and cooling a second region of the metal product to achieve a second temperature profile in the second region of the metal product.

5. The method of claim 1, wherein the spatially non-uniform heat treatment process comprises quenching a first region of the metal product according to a first quench profile and quenching a second region of the metal product according to a second quench profile.

6. The method of claim 1, wherein the spatially non-uniform heat treatment process comprises at least one of heating, cooling, or quenching the metal product using a direct flame impingement process, a magnetic or electromagnetic induction process, a spray cooling or spray quenching process, a thermoelectric heating process, a thermoelectric cooling process, or any combination of these.

7. The method of claim 1, wherein the spatially non-uniform heat treatment process comprises heating or cooling different regions of the metal product using at least a one-dimensional array or a two-dimensional array of heating elements, cooling elements, quenching elements, or any combination of these.

8. The method of claim 1, wherein the metal product comprises a composite product comprising a metal layer and a second layer, wherein the second layer includes one or more of a second metal layer, a fabric layer, a fiber layer, a carbon fiber layer, a polymer layer, a prepolymer layer, or a thermoset plastic layer.

9. The method of claim 1, further comprising stamping the heat treated metal product using a die.

10. The method of claim 1, wherein the custom spatially non-uniform strength profile and the custom spatially non-uniform formability profile are selected to reduce defects imparted in the metal product upon subjecting the metal product to a stamping or drawing process.

11. A metal product comprising:
a heat treated metal product having a spatially non-uniform strength profile and a spatially non-uniform formability profile, generated by treating a metal product with a spatially non-uniform heat treatment, wherein the spatially non-uniform heat treatment includes heating or cooling different regions of the metal product using at least an array of heating elements, cooling elements, quenching elements, or any combination of these.

12. The metal product of claim 11, wherein treating the metal product with a spatially non-uniform heat treatment comprises heating a first region of the metal product to achieve a first temperature profile in the first region of the metal product and heating a second region of the metal product to achieve a second temperature profile in the second region of the metal product that is different from the first temperature profile.

13. The metal product of claim 11, wherein treating the metal product with a spatially non-uniform heat treatment comprises cooling a first region of the metal product to achieve a first temperature profile in the first region of the metal product and cooling a second region of the metal product to achieve a second temperature profile in the second region of the metal product that is different from the first temperature profile.

14. The metal product of claim 11, wherein treating the metal product with a spatially non-uniform heat treatment comprises heating a first region of the metal product to achieve a first temperature profile in the first region of the metal product and cooling a second region of the metal product to achieve a second temperature profile in the second region of the metal product.

15. The metal product of claim 11, wherein treating the metal product with a spatially non-uniform heat treatment comprises quenching a first region of the metal product according to a first quench profile and quenching a second region of the metal product according to a second quench profile.

16. The metal product of claim 11, wherein treating the metal product with a spatially non-uniform heat treatment comprises at least one of heating, cooling, or quenching the metal product using a direct flame impingement process, a magnetic or electromagnetic induction process, a spray cooling or spray quenching process, a thermoelectric heating process, a thermoelectric cooling process, or any combination of these.

17. The metal product of claim 11, wherein the spatially non-uniform heat treatment comprises heating or cooling different regions of the metal product using at least a one-dimensional array or a two-dimensional array of heating elements, cooling elements, quenching elements, or any combination of these.

18. The metal product of claim 11, wherein the metal product comprises a composite product comprising a metal layer and a second layer, wherein the second layer includes one or more of a second metal layer, a fabric layer, a fiber layer, a carbon fiber layer, a polymer layer, a prepolymer layer, or a thermoset plastic layer.

19. The metal product of claim 11, corresponding to a stamped metal product formed by stamping the heat treated metal product using a die.

20. The metal product of claim 11, wherein the spatially non-uniform strength profile and the spatially non-uniform formability profile are selected to reduce defects imparted in the metal product upon subjecting the metal product to a stamping or drawing process.
